(19) United States
(12) Patent Application Publication
(10) Pub. No.: US 2012/0137536 A1
(43) Pub. Date: Jun. 7, 2012

(54) APPLIANCE FOR DRYING LAUNDRY

(75) Inventors: Maurizio Del Pos, Porcia (PN) (IT); Massimiliano Vignocchi, Porcia (PN) (IT); Loris Padovan, Sesto Al Reghena (PN) (IT); Alberto Bison, Porcia (PN) (IT)

(73) Assignee: ELECTROLUX HOME PRODUCTS CORPORATION, N.V., Brussel (BE)

(21) Appl. No.: 13/381,519

(22) PCT Filed: Jun. 24, 2010
(86) PCT No.: PCT/EP2010/058968

§ 371 Date: Feb. 21, 2012

(30) Foreign Application Priority Data
Jun. 29, 2009 (EP) 09164004.5

(51) Int. Cl. F26B 11/02

(52) U.S. Cl. 34/108

(57) ABSTRACT

A laundry drying appliance (100) includes a cabinet (110) having a top (119), a rotating drum (105) accommodated within the cabinet, and a laundry drying air circulation system for circulating drying air though the drum for drying laundry within the drum. The top includes fluid passageways defined thereinside for the circulation of the drying air, and an air-air heat exchanger (535) arranged inside the fluid passageways operable to remove moisture and dehydrate the drying air, a cooling air aspirator (560) for aspirating cooling air (555) from an external environment and causing the cooling air to flow through the air-air heat exchanger for cooling down the drying air and causing the moisture-laden air to condensate, and a perforated top panel (592;1805) having perforations for allowing release of the cooling air to the external environment after the cooling air has passed through the air-air heat exchanger. The perforated top panel defines a garments drying surface adapted to be laid upon by garments to be dried.

### BACKGROUND OF THE INVENTION

1. Field of the Invention

The present invention generally relates to the field of household appliances for laundry and garments treatment. In particular, the present invention relates to appliances for drying laundry, such as laundry dryers and combined washers/dryers.

2. Discussion of the Related Art

Appliances for drying laundry, are adapted to dry clothes, garments, laundry in general, by circulating hot, dry air within a tumbler or drum. The drum is rotatable within a machine cabinet, and is designed to contain the articles to be dried. The rotation of the drum causes agitation of the articles to be dried, while they are hit by the drying air flow.

Combined laundry washer/dryer appliances combine the features of a washing machine with those of a dryer.

In a known type of laundry dryers and washers/dryers, also referred to as “condenser dryer”, the drying air flow is typically caused to pass through the drum, exiting therefrom from the front access opening, then it passes through a moisture condensing system, where the humid air is at least partially dehydrated, dried, and the dried air flow is heated up by means of a heating arrangement, like an electrical resistance; the heated drying air flow then passes again through the drum, and repeats the cycle.

The condensing system may be an air-air heat exchanger, exploiting air taken in from the outside. Examples of laundry dryers exploiting this type of condensing system are provided in EP 254018, EP 1584734, EP 2039819, GB 2075559.

Garments made of delicate textile materials, such as cashmere, are however not adapted to undergo regular drying treatments in a tumble dryer, owing to the mechanical stresses, mainly in the form of impacts, which the textile fibres would be subject to. More gentle drying treatments are thus recommendable for these delicate textiles, such as line drying or flat drying, which on the other hand are rather time-consuming processes.

The solutions disclosed in the European patent applications EP 1845185 and EP 1854916, both in the name of the present Applicant, are effective in eliminating the above cited drawbacks, by providing a household appliance that comprises a cabinet with a worktop defining a drying surface featuring a plurality of apertures, each one of which is fluidly connected with conveying means adapted to deliver a flow of air towards and through said apertures, for gently but rapidly drying garments that are laid upon the worktop drying surface.

### SUMMARY OF THE INVENTION

The present invention proposes a solution that is effective in achieving the advantages of the solutions set forth in the two cited European patent applications, substantially without the need of providing dedicated parts.

In particular, the solution according to the present invention allows household appliance manufacturers to exploit an already existing design of a washing machine for producing and offering to the customers a washer/dryer which further provides the advantages of the solution set forth in the two cited European patent applications.

According to an aspect of the present invention, there is provided a laundry drying appliance comprising a cabinet having a top, a rotating drum accommodated within the cabinet, and a laundry drying air circulation system for circulating drying air though the drum for drying laundry within the drum.

The top includes fluid passageways defined thereinside for the circulation of the drying air, and an air-air heat exchanger arranged inside said fluid passageways operable to remove moisture and dehydrate the drying air, a cooling air aspirator for aspirating cooling air from an external environment and causing the cooling air to flow through the air-air heat exchanger for cooling down the drying air and causing the moisture-laden air to condensate, and a perforated top panel having perforations for allowing release of the cooling air to the external environment after the cooling air has passed through the air-air heat exchanger, said perforated top panel defining a garments drying surface adapted to be laid upon garments to be dryed.

In particular, the top may have formed therein a path for the cooling air, said cooling air path comprising a first path portion through the air-air heat exchanger, and a second path portion downstream the first path portion.

The second path portion may comprise an air gap between the perforated top panel and the air-air heat exchanger.

The top may comprise a partition element interposed between the air-air heat exchanger and the perforated top panel, arranged to define the first path portion of the cooling air through the air-air heat exchanger, and the second path portion of the cooling air through said air gap, said partition element having an aperture putting the first path portion in fluid communication with the second path portion.

The partition element may extend along the perforated top panel below it, so that the first path portion develops under the partition element, whereas the second path portion develops above the partition element.

The air-air heat exchanger may comprise an undulated thermally-conductive part, having undulations defining channels for the passage of the drying air on the underside, and channels for the passage of the cooling air from the overside, said undulated thermally-conductive part being covered by said partition element, said aperture being proximate to a side of the air-air heat exchanger opposite to the side where the cooling air is aspirated, thereby the cooling air passes through said aperture, flows through the air gap and exits from the apertures formed in the top panel.

The drying air circulation system may comprise a drying air return duct through which drying air coming from drum flows, the drying air return duct having an outlet, and a drying air delivery duct through which the drying air is sent back to the drum, the drying air delivery duct having an inlet.

The top preferably forms a ready-to-mount module ready to be mounted to the cabinet, the top having a drying air inlet couplable to said outlet of the drying air return duct, a drying air outlet couplable to said inlet of the drying air delivery duct.

The outlet of the drying air return duct and the inlet of the drying air delivery duct are preferably located at the top of the cabinet and face upwards, and the top may have a top surface and a bottom surface, said drying air inlet and said drying air outlet are provided on the bottom surface and face downwards so as to match and be couplable to the outlet of the drying air return duct and to the inlet of the drying air delivery duct, respectively.

The drying air return duct and the drying air delivery duct are preferably directly or indirectly rigidly connected to the cabinet so as to be stationary with respect to the cabinet to form automatic positioning and centering means for the mounting of the top.

The fluid passageways for the drying air may comprise a first drying air path portion upstream the air-air heat exchanger, and a second drying air path portion downstream the air-air heat exchanger.

In said first drying air path portion a defluff filter is preferably provided.

In said second drying air path portion a mist separator means is preferably provided.

### BRIEF DESCRIPTION OF THE DRAWINGS

These and other features and advantages of the present invention will better appear by reading the following detailed description of some embodiments thereof, provided merely by way of non-limitative examples, description that should be read in conjunction with the attached drawings, wherein:

FIG. 1 is a perspective from the front of an appliance for drying laundry according to an embodiment of the present invention;

FIG. 2 shows in perspective the appliance of FIG. 1 with a worktop unmounted;

FIG. 3A shows in perspective from the rear the appliance of FIG. 2, with lateral and rear walls of the cabinet removed;

FIG. 3B shows a detail of FIG. 3A from another point of view;

FIG. 4 shows in enlarged scale a detail of a part of the appliance of FIG. 3A;

FIG. 5A shows in perspective exploded view a worktop of the appliance of FIG. 2, in an embodiment of the present invention;

FIG. 5B shows the worktop of FIG. 5A from below;

FIG. 6 shows a detail of the worktop of FIG. 5A;

FIG. 7 schematizes the path followed within the worktop of FIG. 5A by laundry drying air to be dehydrated;

FIG. 8 shows another detail of the worktop of FIG. 5A;

FIG. 9 shows still another detail of the worktop of FIG. 5A, particularly an embodiment of mist separation means provided in the worktop;

FIG. 10 shows a condense water drainage arrangement for draining condense water from the worktop of FIGS. 5A and 5B;

FIG. 11 schematically shows a detail of an alternative embodiment of the mist separation means of FIG. 9;

FIG. 12 shows still another alternative embodiment of the mist separation means;

FIG. 13 schematically shows an arrangement for exploiting condense water released by the drying air for generating steam used for refreshing the items to be dried;

FIGS. 14A and 15 shows a solution for generating refreshing steam, in an embodiment of the present invention; in addition, FIG. 14A also shows an alternative construction of a drying air circulation fan and drying air conduit for delivering drying air to the drum;

FIG. 14B shows a detail of the fixation of the drying air circulation fan of FIG. 14A to the machine cabinet; and

FIGS. 16, 17, 18 and 19 show an alternative construction of the worktop of FIG. 5A.

### DETAILED DESCRIPTION OF EMBODIMENTS OF THE INVENTION

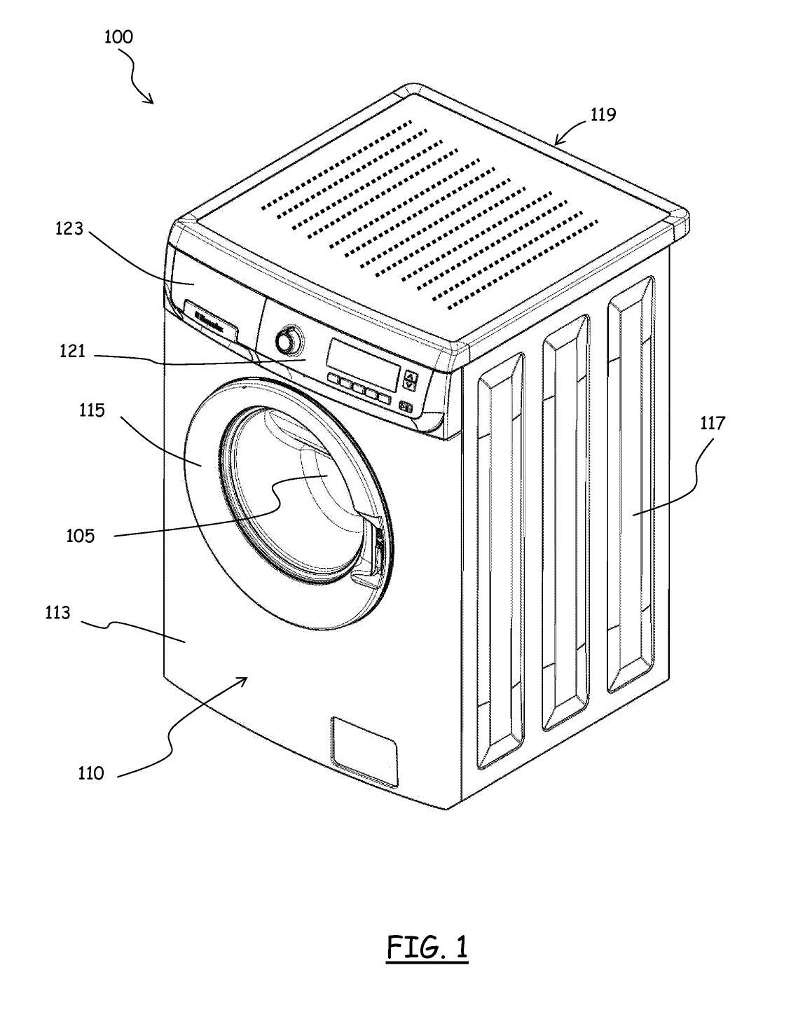

With reference to the drawings, a laundry drying appliance, particularly a washer/dryer according to an embodiment of the present invention is depicted in FIG. 1 in perspective. The washer/dryer, globally denoted as 100, comprises a drum 105 for the loading of the articles to be washed and/or dried, such as clothes, garments, linen, and similar articles. The drum 105 is a generically cylindrical body, for example made of stainless steel, and is rotatable within a tub housed in the machine casing or cabinet 110.

The cabinet 110 is generically a parallelepiped in shape, and has a front wall 113, two side walls 117, a rear wall, a basement and a top 119. The front wall 113 is provided with an opening for accessing the drum 105 and with an associated door 115 for closing the opening. In the upper part of the front wall 113, a machine control panel 121 is located, and, aside the control panel 121, a drawer 123, part of a washing treatment products dispensing arrangement, for loading laundry washing treatment products like detergents and softeners. The top 119 closes the cabinet 110 from above, and defines a worktop.

In the washer/dryer 100, when operated in dryer mode, drying air is typically caused to flow through the drum 105, where the items to be dried are contained. After exiting the drum 105, the flow of moisture-laden drying air passes through a moisture condensing system, where the humid drying air is at least partially dried, dehydrated, and the dehydrated air flow is then heated and caused to pass again through the drum 105, and repeats the cycle.

The moisture condensing system comprises, as described in detail hereinafter, an air-air heat exchanger.

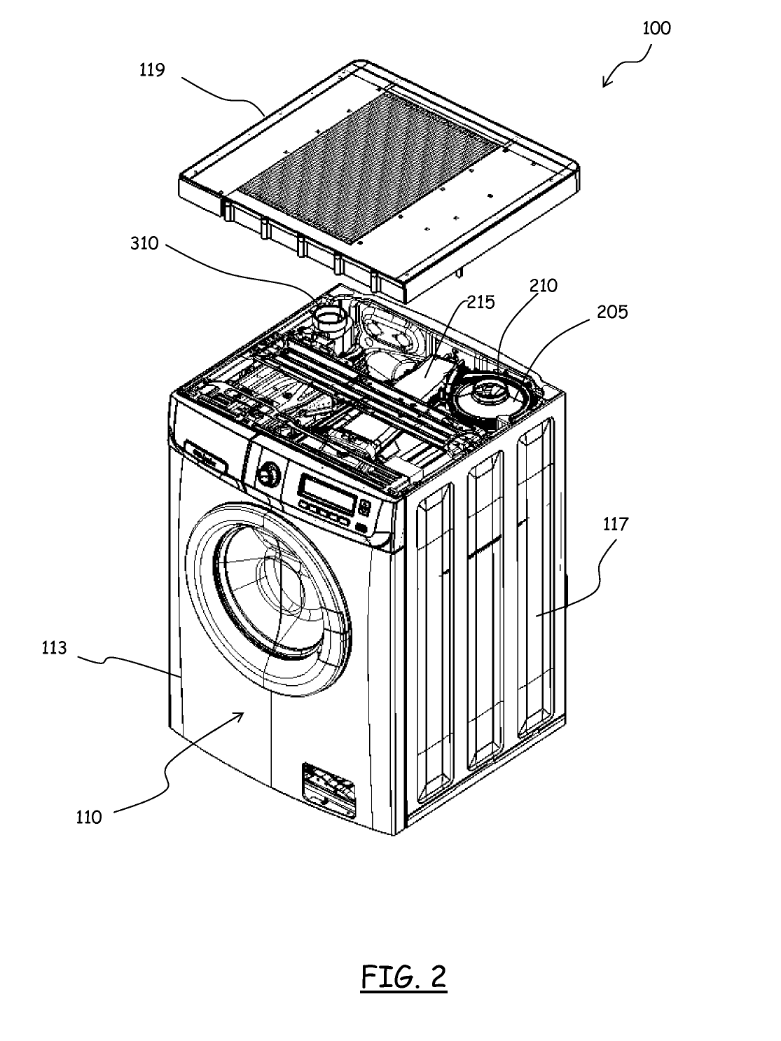

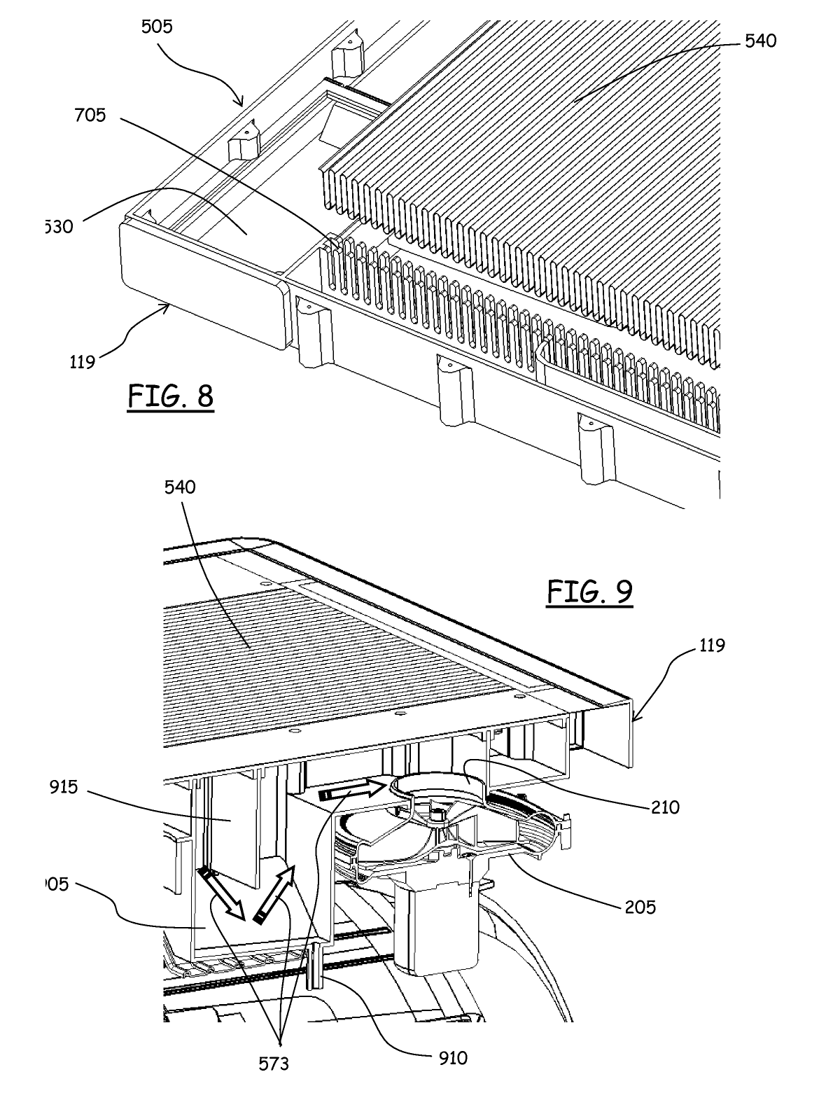

FIGS. 2 to 15 show, in different views, a solution according to a first embodiment of the present invention.

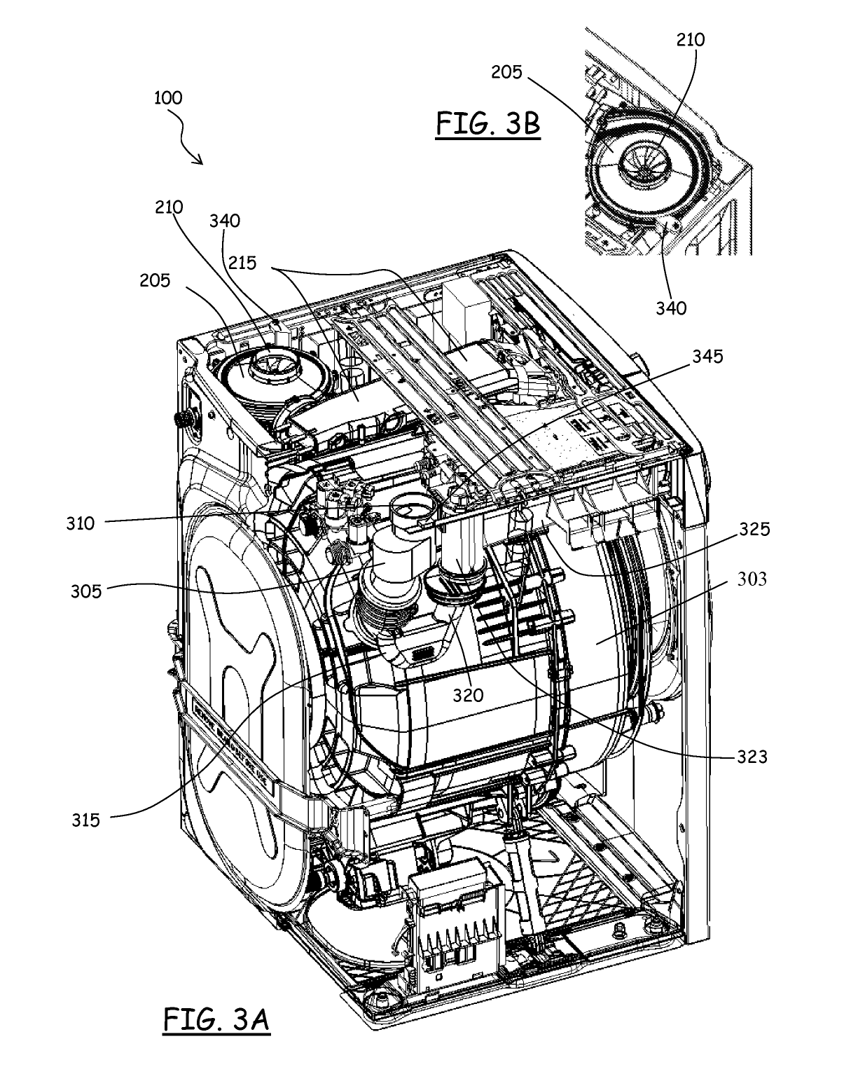

As visible in particular in FIGS. 2 and 3A, 3B, a drying air circulation system is provided in the washer/dryer 100. The drying air circulation system comprises a fan 205, arranged at the rear of the cabinet 110, near the right-top corner thereof. The fan 205, which is fixedly mounted to the cabinet 110, for example by means of a bracket 340 so as to be preferably rigidly connected to the cabinet 110, has an air intake 210 facing upwards and which opens towards the top 119. The fan 205 has an outlet coupled to an inlet of an air duct 215 that runs at the top of the cabinet 110 from the rear to the front thereof, and, through a bellow, conveys the drying air from the fan 205 into the tub 303 and the drum 105 accommodated therein; in particular, the drying air enters the drum 105 in correspondence of the front thereof. An air heater is preferably accommodated within the air duct 215, for example an electrical resistor, so as to heat up the drying air before it enters the drum 105. The drying air circulation system further comprises a return air duct 305, arranged at the rear of the cabinet 110, near the left-top corner thereof and fixedly mounted to the cabinet 110, for example by means of a bracket 345, so as to be preferably rigidly connected to the cabinet 110; the return air duct 305 receives the drying air exiting the drum 105 and the tub 303, and has an outlet 310 that faces upwards and opens towards the top 119; in particular, the drying air exits the drum 105 at the rear thereof, after having passed through the drum so as to hit the items to be dried that are present therein.

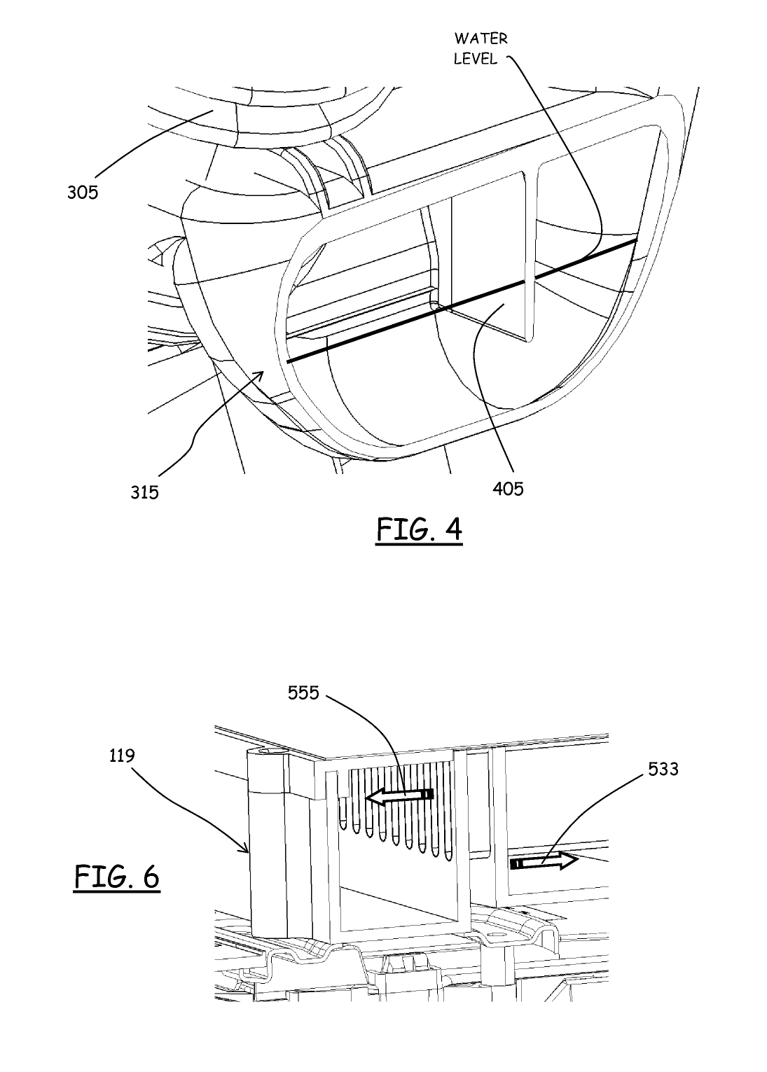

As visible in FIGS. 3A and 4, according to a preferred embodiment of the present invention, the return air duct 305 receives the drying air exiting the drum 105 and the tub 303 through an opening in the tub 303 already provided for feeding thereto the laundry washing treatment products (detergents, softeners) and the clean water used to wash the laundry when the washer/dryer is operated in washing mode. In particular, a manifold 315 is provided, coupled to the opening in the tub 303. The manifold 315 has an inlet pipe 320 that is coupled, by means of a bellow and a duct 323, to an arrangement 325 for dispensing to the tub 303 the laundry washing treatment products (the dispensing arrangement comprising for example a detergent/softener container, one or possibly two electrovalves for intaking cold and possibly hot water from water mains, possibly a mixing chamber for mixing treatment products and water). The manifold 315 has an outlet opening to which, by means of a bellow, the return air duct 305 is connected. Internally, the manifold 315 has a baffle 405 extending down from a top wall of the manifold 315 and defining a siphon: the siphon allows that part of the laundry washing treatment liquid (water mixed with the detergent of the softener, or, possibly, simply water) remains at the bottom of the manifold 315, thereby preventing that, when the appliance is operated in drying mode, the drying air exiting the tub 303 leaks into the treatment products dispending arrangement 325, and that heat is lost, and, at the same time, that humid, moisture-laden air is released into the external environment, which is regarded as undesired because the washer/dryer is installed in-house.

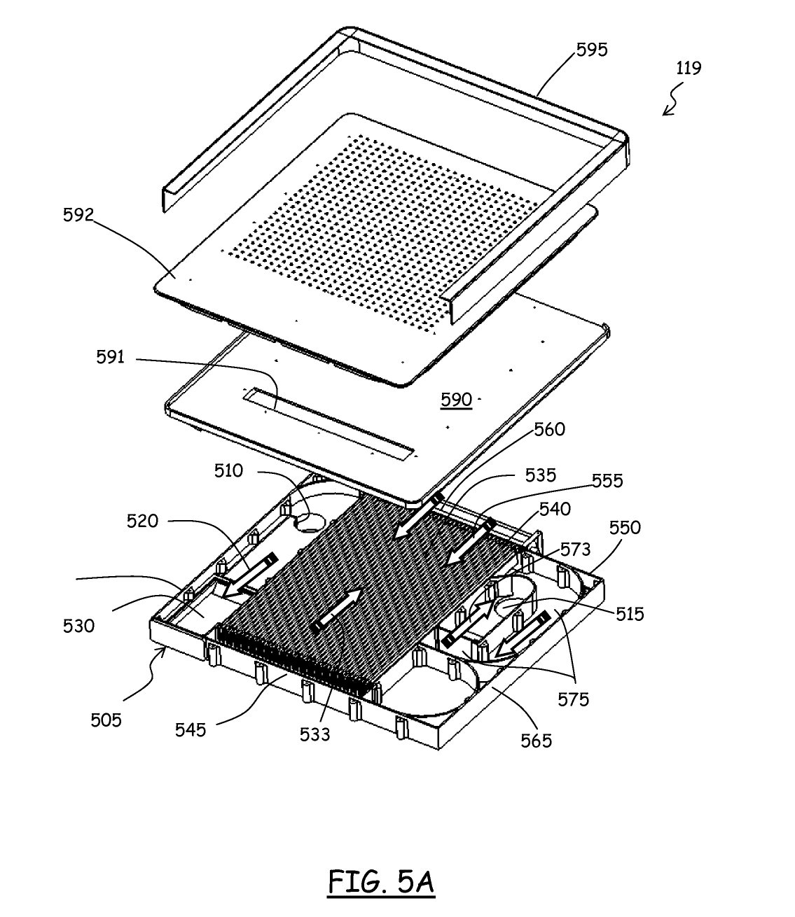

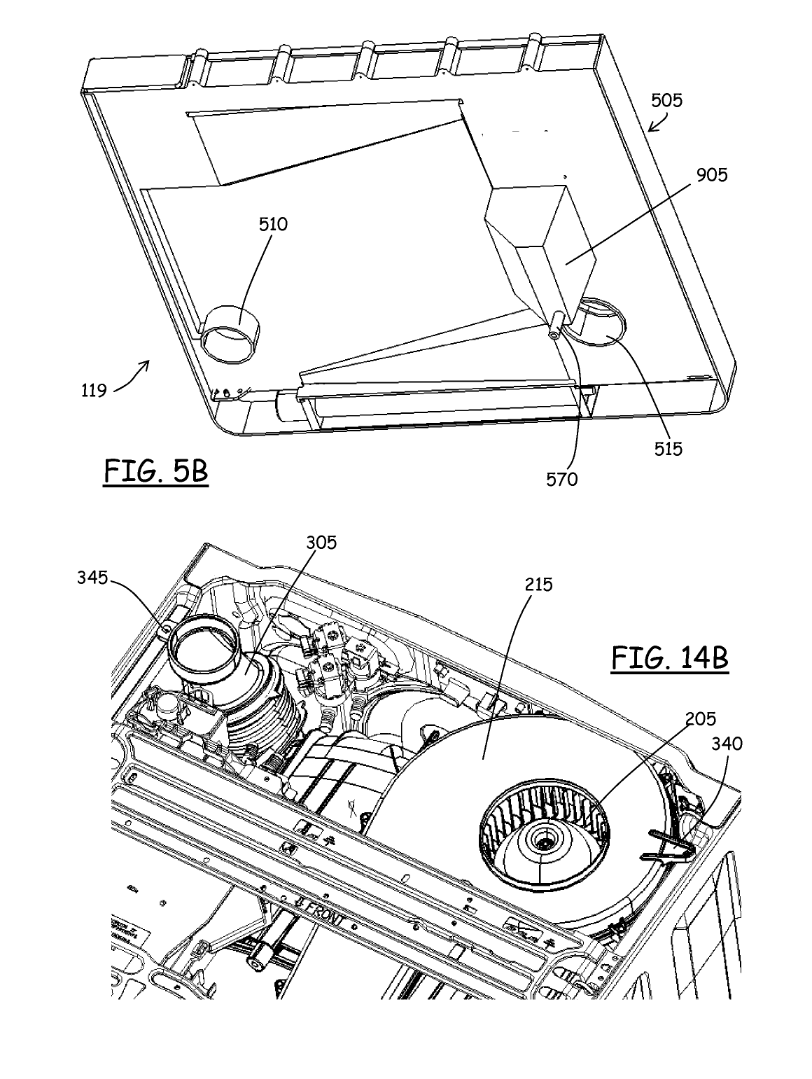

Part of the drying air circulation system is entirely accommodated within the top 119. As visible in the exploded view of FIG. 5A, the top 119 comprises a base element 505, visible from below in FIG. 5B, having shape and size adapted to match and close from above the cabinet 110 when the top 119 is mounted thereto. Proximate to the two rear corners thereof, the base element 505 has two openings 510 and 515; as better described in the following, when the top 119 is assembled and placed on top of the cabinet 110, the opening 510 matches the outlet 310 of the return air duct 305, whereas the opening 515 matches the air intake 210 of the fan 205.

As visible in FIGS. 5A, 6 and 7A, an air path for the drying air is defined in the base element 505 by means of a series of walls. In particular, moisten-laden drying air, indicated by arrow 520 in FIG. 5A, coming from the drum 105 and the tub 303 through the return air duct 305, and entering into the top 119 through the opening 510, initially is caused to flow essentially parallel to the left side 525 of the top 119, from the rear to the front, and to pass through an air defluff filter that is removably accommodated within a respective filter seat 530 formed in the base element 505. Upon exiting the defluff filter, the drying air passes (arrow 533) through a moisture condenser comprising an air-air heat exchanger 535, so as to be cooled down and release moisture in the form of condense water. Advantageously, the air-air heat exchanger 535 is fully accommodated within the top 119, for example, as shown, in the central part thereof.

The air-air heat exchanger 535 comprises a corrugated sheet metal part 540, the undulations of which define channels for the passage of air. The corrugated sheet metal part 540 rests, both at the front and at the rear edges thereof, on a pair of comb-like structures 705 and 710, respectively arranged along a front wall 545 of the base element 505, and along a rear wall 550 of the base element 505. When assembled, the corrugated sheet metal part 540 is glued to the base element 505 by means of glue in between the comb-like structures 705 and 710. When the corrugated sheet metal part 540 rests on the comb-like structures 705 and 710, the undulations define, on the underside of the sheet metal part 540, channels for the flow of the drying air 533 to be cooled down, whereas on the upper side of the sheet metal part 540 the undulations define channels for the flow of cooling air 555 that is taken in from the outside environment by means of a tangential fan 560 mounted to the rear wall 550 of the base element 505. The glue used to attach the corrugated sheet metal part 540 also seals the upper and lower channels for the cooling and drying air. In this way, the drying air 533 that, after passing through the defluff filter, enters the air-air heat exchanger and flows under the corrugated sheet metal part 540, releases heat to the cooling air 555 that flows above the corrugated sheet metal part 540, and cools down, and the moisture present therein is condensed.

After passing through the air-air heat exchanger 535, the cooled drying air 573 exits it from the right rear corner thereof, and then flows along a convoluted air path portion 575 to the opening 515 that is connected to the fan intake 210. Along the convoluted air path portion 575, mist/condense water droplets separation means are provided, for ensuring that mist, condense water droplets are removed from the drying air before it reaches the air fan 205.

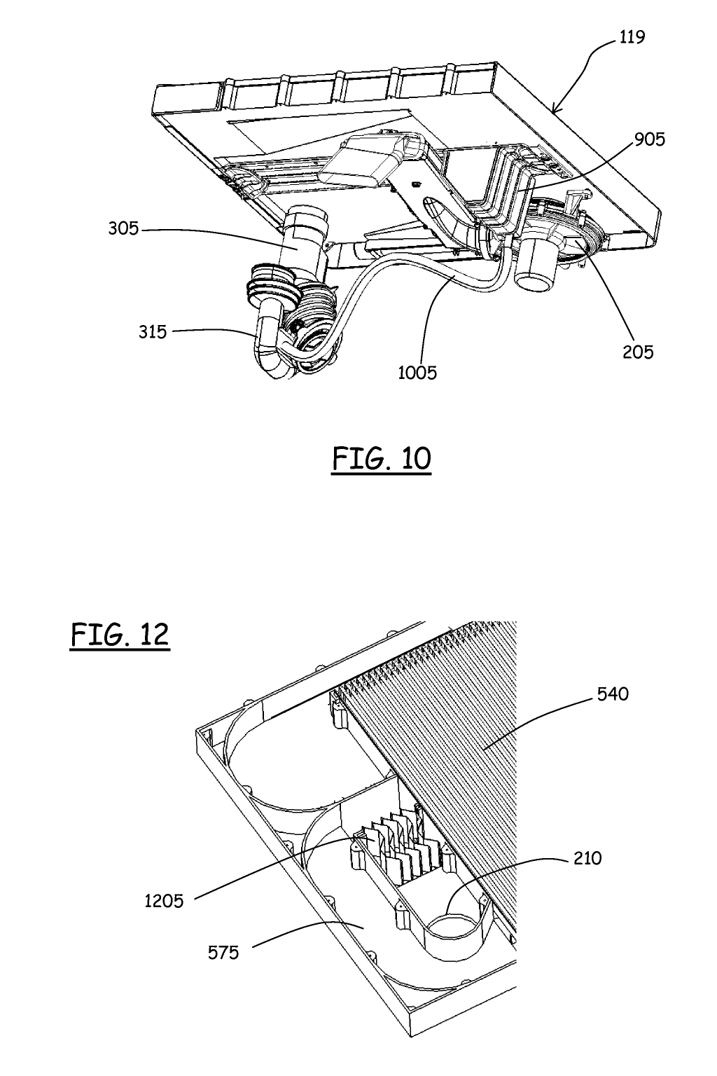

As visible in FIG. 9, in an embodiment of the invention, the mist/condense water droplets separation means comprises a condense water collecting tank 905 formed along the convoluted air path portion 575; droplets of condense water released by the drying air upon passing through the air-air heat exchanger are drawn by the aspiration effect of the fan 205 to the convoluted air path portion 575 and arrives at the tank 905, where they are separated from the drying air and accumulate. At the bottom of the tank 905, a condense water discharge conduit 910 is fluidly connected to the manifold 315, by means of a piping 1005, visible in FIG. 10. In particular, the piping 1005 that connects the condense water discharge conduit 910 to the manifold 315 opens into the latter at a point below the free surface of the water that remains in the siphon defined by the baffle 405; in this way, it is ensured that the condense water is not aspirated by the fan 205. When, due to the discharged condense water, the level of water in the manifold 315 raises excessively, the excess water is discharged into the tub 303, in a position thereof such that the water does not enter the drum, but is instead directly conveyed, via the tub, to a liquid discharge circuit, comprising a discharge pump, provided in the washer/dryer.

As an alternative to discharging the condense water into the manifold 315, the condense water that accumulates in the tank 905 may be directly conveyed to the water discharge pump.

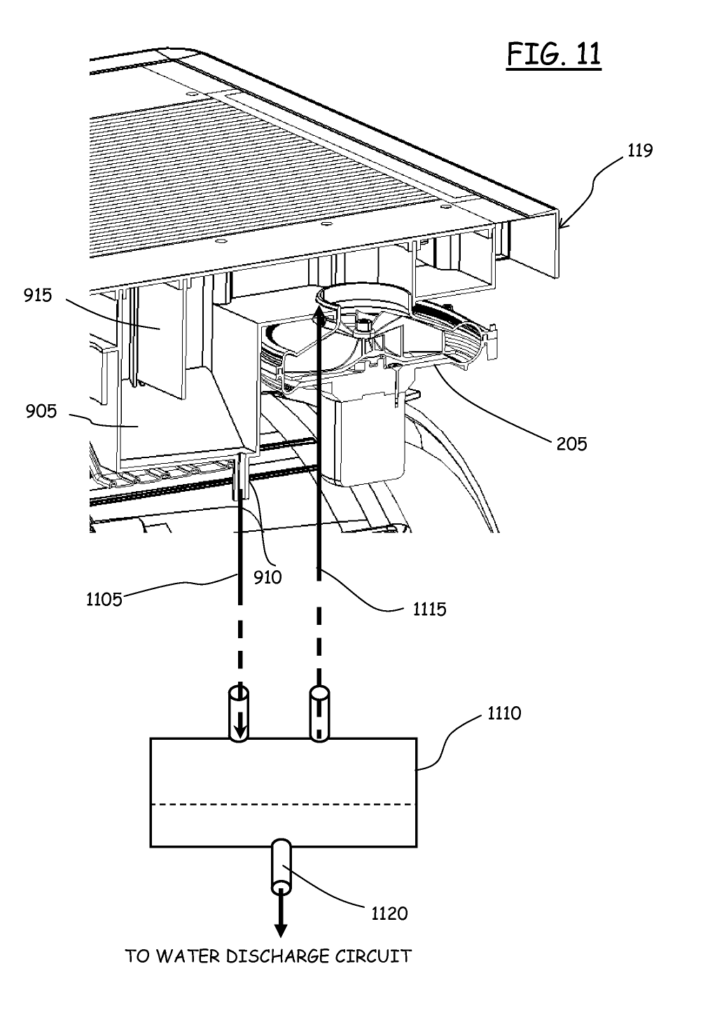

Preferably, as schematically depicted in FIG. 11, in order to avoid that the depression generated by the fan 205 may suck condense water that deposits in the tank 905, the discharge conduit 910 of the tank 905 is fluidly connected, by a conduit 1105, to a lower tank 1110, located at a suitable lower quota with respect to the top 119, for example at or near the basement of the washer/dryer. The lower tank 1110 is further fluidly connected, through a conduit 1115, to a point of the convoluted air path portion 575 located downstream the tank 905, for example close to the air intake 210 of the fan 205. The bottom of the lower tank 1110 has a condense water discharge outlet 1120 that is fluidly connected to the water discharge circuit of the washer/dryer, and thus to the discharge pump.

A baffle 915 is preferably provided in the tank 905, the baffle 915 defining a siphon; the presence of the baffle 915, forming a barrier for the drying air flow, facilitates that water droplets that are transported by the flow of drying air fall into the tank 905, preventing them from reaching the fan 205.

As an alternative to the provision of the baffle 915 shown in FIGS. 9 and 11, a mist separator element 1205 may be accommodated in the tank 905, as depicted in FIG. 12, for promoting the removal of moist droplets from the drying air. The mist separator element 1205 may for example be formed of a plurality of metal or plastic plates bent to define a winding path. Also in this case, the lower tank 1110 may be provided.

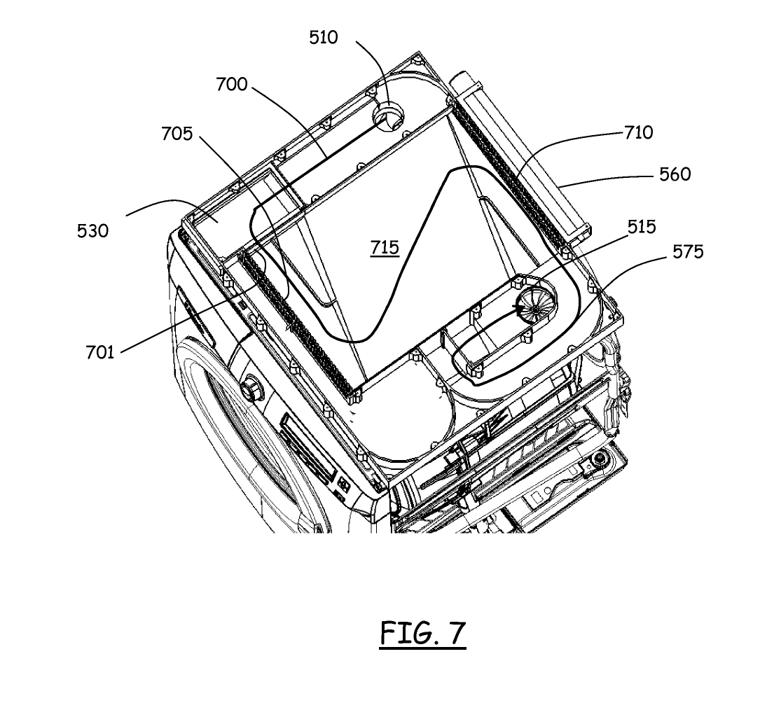

The path followed in the top 119 by the moisten-laden drying air is also schematized in FIG. 7, and indicated therein as 700. The drying air passes through the defluff filter vertically, from the top to the bottom filter surfaces, and exits the filter seat 530 (for then entering into the air-air heat exchanger) passing through an opening 701 formed along a bottom of a side wall of the filter seat 530.

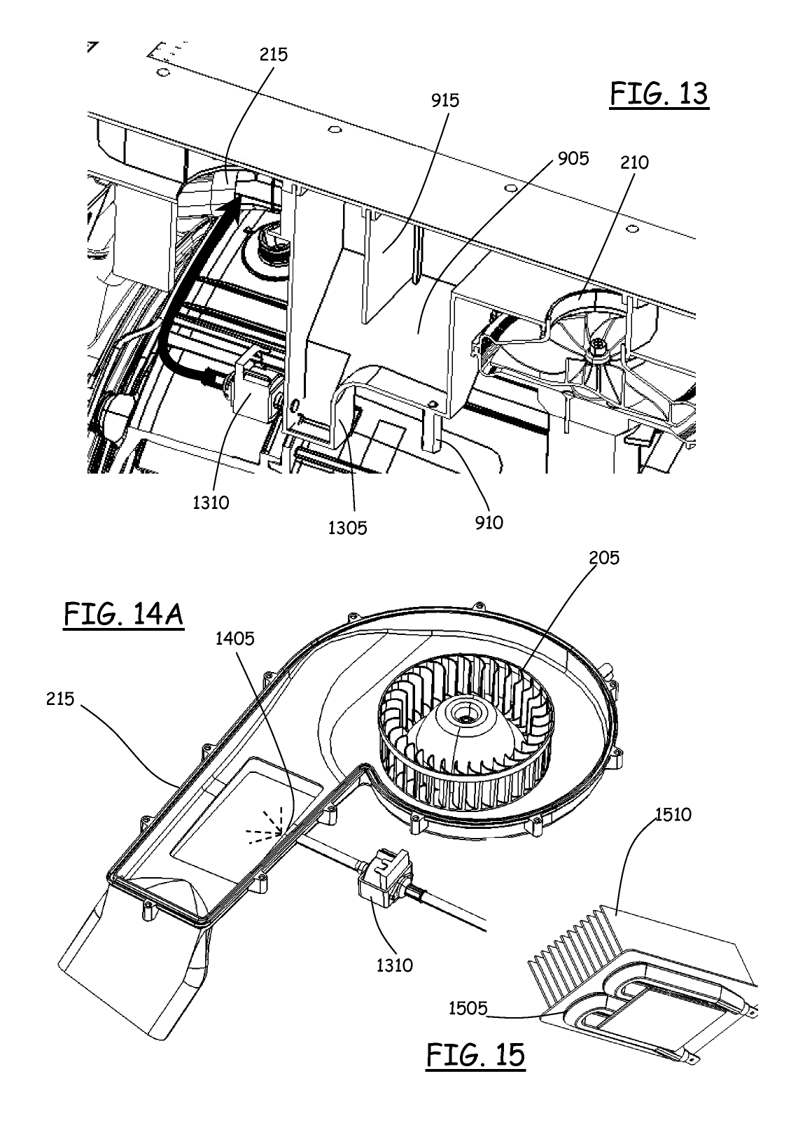

The condense water that accumulates in the tank 905 may be exploited for generating steam used for refreshing the items to be dried during the drying cycle. As schematized in FIGS. 13 and 14A, the tank 905 may be shaped so as to have a deeper portion 1305, defining a reservoir for water used to generate steam. A pump 1310 has an inlet connected to the tank deeper portion 1305; the pump 1310 has an outlet fluidly connected to a nozzle 1405 arranged to spray inside the air duct 215, preferably in a point thereof where there is the electrical resistor provided for heating the drying air; in this way, the heat generated by the resistor cause the water sprayed by the pump 1305 to vaporize, and steam is generated that is useful for refreshing the items being dried. The resistor may be mounted internally or externally to the air duct 215; in case the resistor is mounted within the air duct 215, an armoured resistor should be used. For a more efficient operation, as depicted in FIG. 15, the drying air heating resistor 1505 may be associated with a heat dissipator/radiator 1510 having fins, that is accommodated within the air duct 215. In this way, the effect of drying air heating and of vaporisation of the water sprayed by the pump 1310 is enhanced.

In FIGS. 14A and 14B there is also shown a variant of the construction of the fan 205 and air duct 215, in which the air duct 215 is shaped so as to also define a housing for the fan 205; the air duct is made of two half-shells, and is fixedly, rigidly mounted to the cabinet 110 by means of the bracket 340, as visible in FIG. 14B.

Referring back to FIG. 5A, a panel 590 covers the base element 505, closing from above the air path defined in the base element 505 for the drying air, and covering the corrugated sheet metal plate 540.

The panel 590 has an elongated aperture 591 extending parallelly to the front of the top 119, from which aperture 591 the cooling air 555, after having passed through (the channels defined by the undulations on top of the corrugated metal part 540 of) the air-air heat exchanger 535, exits. Above the panel 590, a perforated panel 592 rests, slightly spaced apart from the panel 590, so as to leave an air gap between the two panels 590 and 592. The cooling air 555 that is taken in from the external environment by the tangential fan 560, heated by the heat released by the drying air 533, upon reaching the front side of the corrugated part 540 passes through the aperture 591 in the panel 590, then flows in the air gap between the panel 590 and the perforated panel 592, and exits from the perforations in the panel 592. In this way, the top 119 may be exploited for laying thereon delicate garments to be dried that, due to their nature, cannot be dried within the tumbling drum without being damaged. The top 119 thus defines thereinside a path for the drying air to be cooled down, and another path for the cooling air which is also exploited for drying delicate garments by laying them on the perforated surface of the panel 592. In particular, the path for the cooling air comprises a first path portion, where the cooling air flows along the channels defined by the undulations of the corrugated part 540, and a second path portion, where the cooling air, after having passed through the aperture 591, flows in the air gap between the panels 590 and 592, and leaks through the perforations of the panel 592.

A frame 595 may be provided for laterally surrounding the panels 592, 590 and the base element 505.

In the preferred embodiment described, the top 119, once assembled, forms a unit that is ready to be mounted to the cabinet 110, simply by placing it in the correct alignment, so that the openings 510 and 515 matches the outlet 310 of the return air duct 305 and, respectively, the intake 210 of the air circulation fan 205. As mentioned in the foregoing, both the return air duct 305 and the fan 205 are fixed, rigidly connected to the machine cabinet 110; in this way, the outlet 310 of the return air duct 305 and the air intake 210 of the air circulation fan 205 act as automatic positioning and centering means for the top 119, thereby greatly simplifying the mounting thereof. The operation of mounting of the top onto the cabinet simply consists in laying the top 119 on the cabinet properly positioning it with the help of the self-centering action achieved by the matching of the openings 510 and 515 with the outlet 310 and air intake 210; in this way, all the necessary connections for the drying air circulation circuit are completed, and there is no necessity to perform any additional connection (exception made for the connection of the condense water discharge piping 1005). The top 119 may then be secured to the cabinet 110 by conventional means. Thanks to the fact that several components of the drying air circulation system, particularly the moisture condensing system, are accommodated within the top 119, several problems of space within the cabinet 110 are overcome; essentially, only the fan 205, the air duct 215, and the return air duct 305 need to be accommodated within the cabinet 110. This reduces problems of space within the cabinet 110, and makes it easier to exploit an already existing design of a washing machine to transform it into a washer/dryer, without having to make substantial changes.

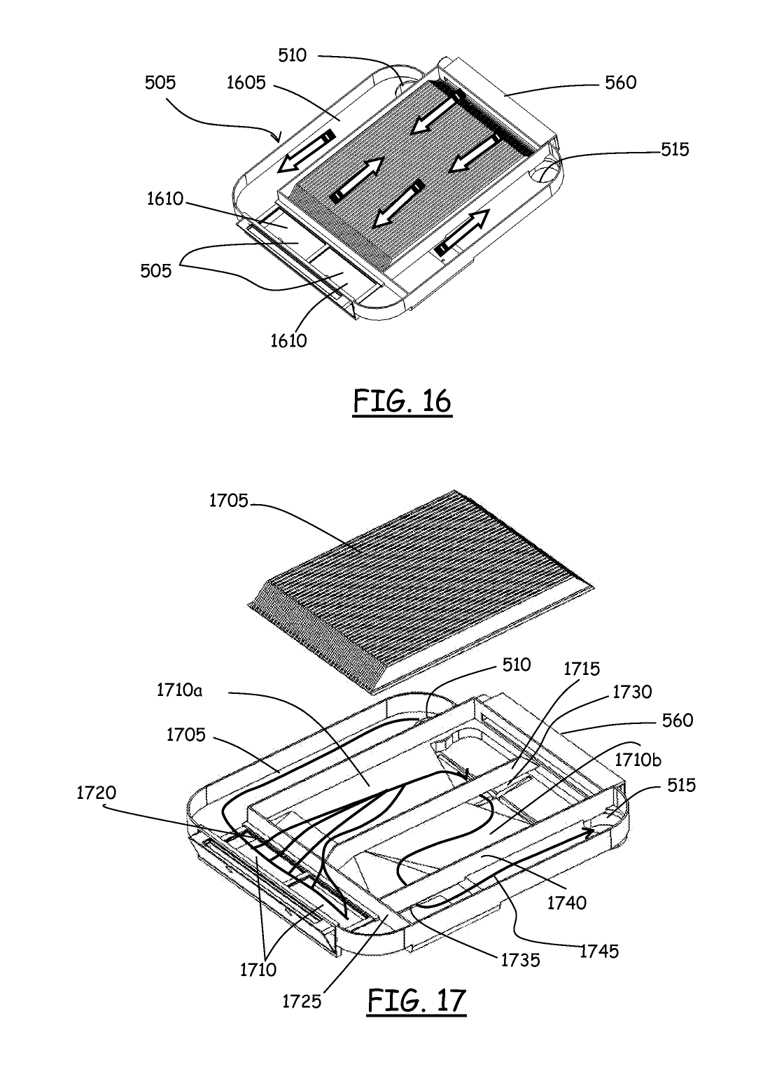

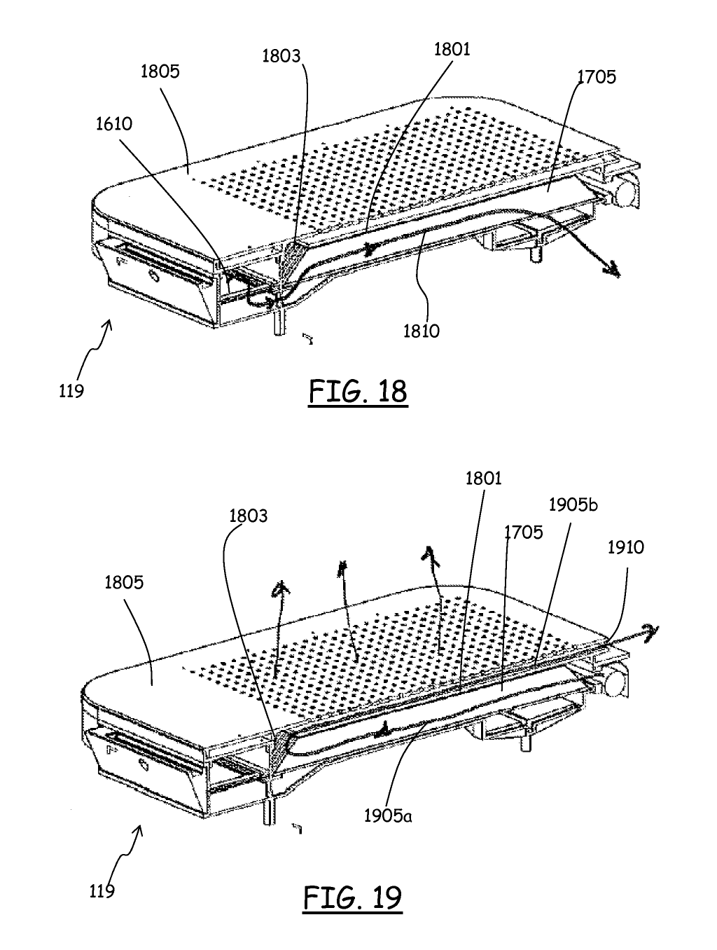

A top 119 according to a variant of the embodiment just described is depicted in FIGS. 16-19. In this case, the drying air to be cooled down for releasing the moisture and be dehydrated passes through the air-air heat exchanger twice, once going from the front towards the rear, and then back towards the front, as schematized in FIG. 17. This double passage improves the action of cooling of the drying air by the cooling air, and thus improves the release of moisture. In particular, the drying air, entering into the top 119 through the opening 510, flows along a substantially rectilinear path 1605 defined in the base element along the left side thereof, from the back to the front, and then enters a defluff filter 1610, which in this alternative is accommodated along the front side of the base element 505. The drying air passes through the defluff filter (from the top to the bottom thereof), and then enters the air-air heat exchanger. As in the previously described embodiment, the air-air heat exchanger comprises a corrugated sheet metal part 1705, the undulations defining channels for the passage of the drying air (under the corrugated sheet metal part 1705) and for the cooling air (above the corrugated sheet metal part 1705). The region of the base element 505 destined to accommodating the corrugated sheet metal part 1705 is divided in two parts 1710a, 1710b, separated by a wall 1715 extending parallelly to the side walls of the base element 505. The drying air passes from the filter to the air-air heat exchanger flowing through a passage 1720 formed at the bottom of a wall 1725 that separates the filter lodging from the region of the air-air heat exchanger, said passage being located on the left side of the base element. The drying air flows under the corrugated sheet metal part 1705 in the first part 1710a of the base element 505, then, at the rear of the base element 505, the drying air passes to the second part 1710b of the base element passing through a passage 1730 formed at the bottom of the wall 1715. The drying air then flows under the corrugated sheet metal part 1705 in the second part 1710b of the base element 505 to the front, and exits the air-air heat exchanger passing through an aperture 1735 below a lateral wall 1740 of the base element 505 that delimits the region thereof accommodating the corrugated sheet metal part 1705. The cooled drying air thus exits the air-air heat exchanger from the front-right corner thereof, then the drying air flows along an essentially straight air path 1745 towards the opening 515, where there is the intake 210 of the fan 205. For the discharge of the condense water that is released by the drying air, solutions similar to those described above are exploitable. As shown in FIGS. 18 and 19, similarly to the embodiment of FIG. 5A, a panel 1801 covers the sheet metal part 1705; the panel 1801 has an aperture 1803 along the front of the top 119; the top 119 has a top panel 1805, superimposed with an air gap to the panel 1801; the top panel 1805 of the top 119 also in this case is perforated, for the passage and exit of the cooling air, so as to provide a working surface for lying delicate garments that are not suitable to be dried by putting them into the tumbling drum of the machine. The top 119 thus defines thereinside a path for the drying air 1810 to be cooled down, and another path for the cooling air 1905 which is also exploited for drying delicate garments by laying them on the perforated surface of the panel 1805. In particular, the path for the cooling air comprises a first path portion 1905a, where the cooling air flows along the channels defined by the corrugated sheet metal part 1705, and a second path portion 1905b, where the cooling air, after having passed through the aperture 1803, flows in the air gap between the panels 1801 and 1805, and leaks through the perforations formed in the latter.

A cooling air discharge opening 1910 may optionally be provided at the rear of the air gap between the panels 1801 and 1805.

Several modifications to the embodiments described in the foregoing can be envisaged.

In particular, although the construction of the top 119 as a ready-to-mount module ready to be mounted to the casing is particularly preferable, this is not to be construed as a limitation for the present invention.

1. A laundry drying appliance comprising a cabinet having a top, a rotating drum accommodated within the cabinet, and a laundry drying air circulation system for circulating drying air though the drum for drying laundry within the drum;
wherein, the top includes fluid passageways defined thereinside for the circulation of the drying air, and an air-air heat exchanger arranged inside said fluid passageways operable to remove moisture and dehydrate the drying air, a cooling air aspirator for aspirating cooling air from an external environment and causing the cooling air to flow through the air-air heat exchanger for cooling down the drying air and causing the moisture-laden air to condensate, and a perforated top panel having perforations for allowing release of the cooling air to the external environment after the cooling air has passed through the air-air heat exchanger, said perforated top panel defining a garments drying surface adapted to be laid upon by garments to be dryed.

2. The laundry drying appliance of claim 1, wherein the top has formed therein a path for the cooling air, said cooling air path comprising a first path portion through the air-air heat exchanger, and a second path portion downstream of the first path portion.

3. The laundry drying appliance of claim 2, wherein the second path portion comprises an air gap between the perforated top panel and the air-air heat exchanger.

4. The laundry dryer appliance of claim 3, wherein the top comprises a partition element interposed between the air-air heat exchanger and the perforated top panel, arranged to define the first path portion of the cooling air through the air-air heat exchanger, and the second path portion of the cooling air through said air gap, said partition element having an aperture putting the first path portion in fluid communication with the second path portion.

5. The laundry dryer appliance of claim 4, wherein the partition element extends along the perforated top panel below it, so that the first path portion extends under the partition element, whereas the second path portion extends above the partition element.

6. The laundry drying appliance of claim 3, wherein said air-air heat exchanger comprises an undulated thermally-conductive part, having undulations defining channels for the passage of the drying air on the underside, and channels for the passage of the cooling air on the overside, said undulated thermally-conductive part being covered by said partition element, said aperture being proximate to a side of the air-air heat exchanger opposite to the side where the cooling air is aspirated, whereby the cooling air passes through said aperture, flows through the air gap and exits from the apertures formed in the top panel.

7. The laundry drying appliance of claim 1, wherein:
the drying air circulation system comprises a drying air return duct through which drying air coming from drum flows, the drying air return duct having an outlet, and a drying air delivery duct through which the drying air is sent back to the drum, the drying air delivery duct having an inlet;
and wherein:
the top forms a ready-to-mount module ready to be mounted to the cabinet, the top having a drying air inlet couplable to said outlet of the drying air return duct, a drying air outlet couplable to said inlet of the drying air delivery duct.

8. The laundry drying appliance of claim 7, wherein said outlet of the drying air return duct and said inlet of the drying air delivery duct are located at the top of the cabinet and face upwards, and wherein the top has a top surface and a bottom surface, said drying air inlet and said drying air outlet are provided on the bottom surface and face downwards so as to match and be couplable to the outlet of the drying air return duct and to the inlet of the drying air delivery duct, respectively.

9. The laundry drying appliance of claim 7, wherein the drying air return duct and the drying air delivery duct are directly or indirectly rigidly connected to the cabinet so as to be stationary with respect to the cabinet to form automatic positioning and centering structure for the mounting of the top.

10. The laundry drying appliance of claim 1, wherein said fluid passageways for the drying air comprises a first drying air path portion upstream the air-air heat exchanger, and a second drying air path portion downstream the air-air heat exchanger.

11. The laundry drying appliance of claim 10, wherein in said first drying air path portion a defluff filter is provided.

12. The laundry drying appliance of claim 10, wherein in said second drying air path portion a mist separator is provided.

13. The laundry drying appliance of claim 4, wherein said air-air heat exchanger comprises an undulated thermally-conductive part, having undulations defining channels for the passage of the drying air on the underside, and channels for the passage of the cooling air on the override, said undulated thermally-conductive part being covered by said partition element, said aperture being proximate to a side of the air-air heat exchanger opposite to the side where the cooling air is aspirated, whereby the cooling air passes through said aperture, flows through the air gap and exits from the apertures formed in the top panel.

14. The laundry drying appliance of claim 5, wherein said air-air heat exchanger comprises an undulated thermally-conductive part, having undulations defining channels for the passage of the drying air on the underside, and channels for the passage of the cooling air on the overside, said undulated thermally-conductive part being covered by said partition element, said aperture being proximate to a side of the air-air heat exchanger opposite to the side where the cooling air is aspirated, whereby the cooling air passes through said aperture, flows through the air gap and exits from the apertures formed in the top panel.

15. The laundry drying appliance of claim 4, wherein:
the drying air circulation system comprises a drying air return duct through which drying air coming from drum flows, the drying air return duct having an outlet, and a drying air delivery duct through which the drying air is sent back to the drum, the drying air delivery duct having an inlet;
and wherein:
the top forms a ready-to-mount module ready to be mounted to the cabinet, the top having a drying air inlet couplable to said outlet of the drying air return duct, a drying air outlet couplable to said inlet of the drying air delivery duct.

16. The laundry drying appliance of claim 6, wherein:
the drying air circulation system comprises a drying air return duct through which drying air coming from drum flows, the drying air return duct having an outlet, and a drying air delivery duct through which the drying air is sent back to the drum, the drying air delivery duct having an inlet;
and wherein:
the top forms a ready-to-mount module ready to be mounted to the cabinet, the top having a drying air inlet couplable to said outlet of the drying air return duct, a drying air outlet couplable to said inlet of the drying air delivery duct.

17. The laundry drying appliance of claim 8, wherein the drying air return duct and the drying air delivery duct are directly or indirectly rigidly connected to the cabinet so as to be stationary with respect to the cabinet to form automatic positioning and centering structure for the mounting of the top.

18. The laundry drying appliance of claim 2, wherein said fluid passageways for the drying air comprise a first drying air path portion upstream the air-air heat exchanger, and a second drying air path portion downstream the air-air heat exchanger.

19. The laundry drying appliance of claim 3, wherein said fluid passageways for the drying air comprise a first drying air path portion upstream the air-air heat exchanger, and a second drying air path portion downstream the air-air heat exchanger.

20. The laundry drying appliance of claim 11, wherein in said second drying air path portion a mist separator is provided.
